(19) United States
(12) Patent Application Publication
(10) Pub. No.: US 2026/0223830 A1
(43) Pub. Date: Aug. 6, 2026

(54) SYSTEMS AND METHODS FOR LIVEWELLS

(71) Applicant: Candy Baits LLC dba Wicked Wells, North Palm Beach, FL (US)

(72) Inventors: Joseph Fitch Carrere, Atlanta, GA (US); Ryan Wayne Radloff, North Palm Beach, FL (US)

(21) Appl. No.: 19/465,157

(22) Filed: Jan. 30, 2026

Related U.S. Application Data
(60) Provisional application No. 63/752,198, filed on Jan. 31, 2025.

(51) Int. Cl. A01K 97/20

(52) U.S. Cl. CPC A01K 97/20

(57) ABSTRACT

The disclosed technology includes a method of installing an apparatus into a livewell. The method including inserting at least a portion of a spillover apparatus into an opening of the livewell with the spillover apparatus comprising a first portion defining a first opening and a first channel extending around at least a portion of the first portion and a second portion defining a second opening and a second channel extending around at least a portion of the second portion. The method can further include positioning the first portion on top of at least a portion of the second portion such that, the first channel of the first portion collects spillover liquid from the opening of the livewell. The inserting can comprise aligning the second opening with at least a portion of the opening of the livewell and aligning the first opening with at least a portion of the second opening.

### CROSS-REFERENCE TO RELATED APPLICATIONS

This application claims the benefit of priority under 35 U.S.C. § 119 to prior filed U.S. Provisional Patent Application No. 63/752,198 filed on Jan. 31, 2025, the entire contents of which is hereby incorporated by reference as if set forth in full herein.

### FIELD OF INVENTION

The present disclosure relates to livewell systems for fishing boats, and more particularly to systems and methods for preventing water from spilling out of livewell systems.

### BACKGROUND

A livewell is a specialized tank commonly found on fishing boats, designed to keep bait fish or caught fish alive and healthy during fishing trips. One of the primary functions of a livewell is to circulate water from the surrounding environment, thereby maintaining optimal oxygen levels and temperature for the fish. This system preserves the fish in a viable condition for either later release or transport, ensuring they remain in good health.

By continuously refreshing the water within the tank, these systems prevent the buildup of waste products and maintain a stable environment that mimics the natural habitat of the fish. Some advanced livewells are even pressurized to further optimize the conditions within the tank, enhancing the survival rate of the fish.

However, livewells are prone to certain operational challenges. One challenge is the tendency for water to leak or splash out of the tank, particularly when the boat is in motion or when fish are active in the tank. This can result in the loss of water, which can be potentially harmful to the fish. Further, the splashing water can create a slipping hazard on the boat, which can be dangerous and inconvenient for the crew.

Many existing livewell systems lack adequate mechanisms to prevent water overflow while maintaining the functionality and accessibility that users require. Additionally, retrofitting existing livewells with improved overflow management capabilities presents technical challenges related to installation, sealing, and integration with existing plumbing systems.

Thus, there is a clear need for an improved livewell system that effectively prevents water from leaking out of the tank while still allowing for easy access to the fish within the tank. Further, there is a need for systems and methods for installing an apparatus to livewell systems to overcome the foregoing issues. These and other problems are addressed by the technology disclosed herein.

### SUMMARY

The disclosed technology can include a method of installing an apparatus into a livewell. The method can comprise inserting at least a portion of a spillover apparatus into an opening of the livewell. The spillover apparatus can comprise a first portion defining a first opening and a first channel extending around at least a portion of the first portion, and a second portion defining a second opening and a second channel extending around at least a portion of the second portion. The method can further comprise positioning the first portion on top of at least a portion of the second portion such that, the first channel of the first portion collects spillover liquid from the opening of the livewell.

The inserting can comprise aligning the second opening with at least a portion of the opening of the livewell and aligning the first opening with at least a portion of the second opening.

According to another aspect of the present disclosure, the disclosed technology can include an apparatus for a livewell. The apparatus can comprise a first portion defining a first opening aligned with at least a portion of a second opening and a first channel extending around at least a portion of the first portion, the first channel configured to collect spillover liquid from the first opening. The apparatus can also comprise a second portion disposed at least partially beneath the first portion and defining the second opening aligned with at least a portion of an opening of the livewell and a second channel extending around at least a portion of the second portion, the second channel configured to receive spillover liquid from the first channel. At least a portion of the first portion and/or the second portion can be configured to be secured to the livewell.

Additional features, functionalities, and applications of the disclosed technology are discussed herein in more detail.

### BRIEF DESCRIPTION OF FIGURES

Implementations, features, and aspects of the disclosed technology are described in detail herein and are considered a part of the claimed disclosed technology. Other implementations, features, and aspects can be understood with reference to the following detailed description, accompanying drawings, and claims. Wherever possible, the same reference numbers are used throughout the drawings to refer to the same or like members of an embodiment. Reference will now be made to the accompanying figures and flow diagrams, which are not necessarily drawn to scale.

FIG. 1A illustrates a perspective view of a livewell system, in accordance with the disclosed technology.

FIG. 1B illustrates a perspective view of a livewell system, in accordance with the disclosed technology.

FIG. 1C illustrates a top view of a livewell system, in accordance with the disclosed technology.

FIG. 1D illustrates a top view of a livewell system, in accordance with the disclosed technology.

FIG. 2A illustrates an exploded perspective view of an exemplary livewell system, in accordance with the disclosed technology.

FIG. 2B illustrates an exploded perspective view of an exemplary livewell system, in accordance with the disclosed technology.

FIG. 3A illustrates a perspective view of a bottom portion of an exemplary livewell system, in accordance with the disclosed technology.

FIG. 3B illustrates a perspective view of the bottom portion of an exemplary livewell system, in accordance with the disclosed technology.

FIG. 4 illustrates a perspective view of an exemplary livewell system, in accordance with the disclosed technology.

FIG. 5A illustrates a top perspective view of an exemplary lid for a livewell system, in accordance with the disclosed technology.

FIG. 5B illustrates a top perspective view of an alternative lid configuration, in accordance with the disclosed technology.

FIG. 6 illustrates an exemplary flowchart for a method of installing an apparatus into a livewell, in accordance with the disclosed technology.

### DETAILED DESCRIPTION

The disclosed technology includes devices, systems, and methods for modifying existing livewells to reduce or eliminate water loss from a livewell. For example, the disclosed technology includes a livewell device that prevents water from leaking out of the tank. The device can be applied to existing livewells of varying heights, diameters, widths and shapes, both as a stand-alone unit, or fixed into the livewells integrated into boats, for example in the transoms and/or other portions of the boats.

Aspects of the disclosed technology will be described more fully hereinafter with reference to the accompanying drawings. This disclosed technology can, however, be embodied in many different forms and should not be construed as limited to the examples set forth therein.

In the following description, numerous specific details are set forth. However, it is to be understood that various examples of the disclosed technology can be practiced without these specific details. In other instances, well-known methods, structures, and techniques have not been shown in detail in order to not obscure an understanding of this description. References to “one embodiment,” “an embodiment,” “example embodiment,” “some embodiments,” “certain embodiments,” “various embodiments,” “one example,” “an example,” “some examples,” “certain examples,” “various examples,” etc., indicate that the example(s) of the disclosed technology so described can include a particular feature, structure, or characteristic, but not every implementation of the disclosed technology necessarily includes the particular feature, structure, or characteristic.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including,” etc. is meant that at least the named compound, member, particle, or method step is present in the composition or article or method, but does not exclude the presence of other compounds, materials, particles, method steps, even if the other such compounds, material, particles, method steps have the same function as what is named.

Herein, the use of terms such as “having,” “has,” “including,” “includes,” etc. are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

The disclosed technology provides systems and methods for addressing operational challenges associated with livewells on fishing boats. Livewells may experience water leakage and splashing during boat operation, which can harm fish health and create safety hazards on deck surfaces. The disclosed technology offers a retrofittable solution that may be applied to existing livewell and/or offers an apparatus that may be applied to newly built boats with one or more livewells to prevent water overflow while maintaining access to fish within the tank. The disclosed technology offers a solution that may be applied to newly built boats with one or more livewells to prevent water overflow while maintaining access to fish within the tank. The disclosed technology offers a retrofittable solution that may be applied to existing livewell installations to prevent water overflow while maintaining access to fish within the tank. In other embodiments, the disclosed technology can be integrated into one or more livewells installed on a boat and/or one or more livewells integrated into a boat, for example in the transoms and/or other portion of the boat. Further, the disclosed technology can be integrated into existing livewells on a boat or directly into a boat's livewell as the boat is being built.

The system may comprise multiple components that work together to collect overflow water and enable pressurization of the livewell environment. In some cases, the system includes a top portion configured as a recessed gutter that catches spillover water, and a bottom portion that forms a collection chamber for managing the collected spillover liquid. The system may be designed to fit within existing livewell openings, allowing boat owners to upgrade their current installations without replacing the entire livewell structure.

The design of the spillover apparatus may accommodate livewells of varying dimensions, shapes, and configurations. In some cases, the system includes drainage mechanisms that direct overflow water away from the boat deck or recycle the water back into the livewell system. The components may be configured to create sealed connections that enable pressurization of the livewell, which can enhance fish survival rates during transport and storage.

The following detailed description provides comprehensive information regarding the structural components, their spatial relationships, and operational characteristics. The description covers the top portion gutter system, the bottom portion collection chamber, lid configurations with sealing mechanisms, and installation methods of a spillover apparatus to a livewell. Each component may be described in terms of construction, positioning, and functional interaction with other system elements to provide a complete understanding of the disclosed technology.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

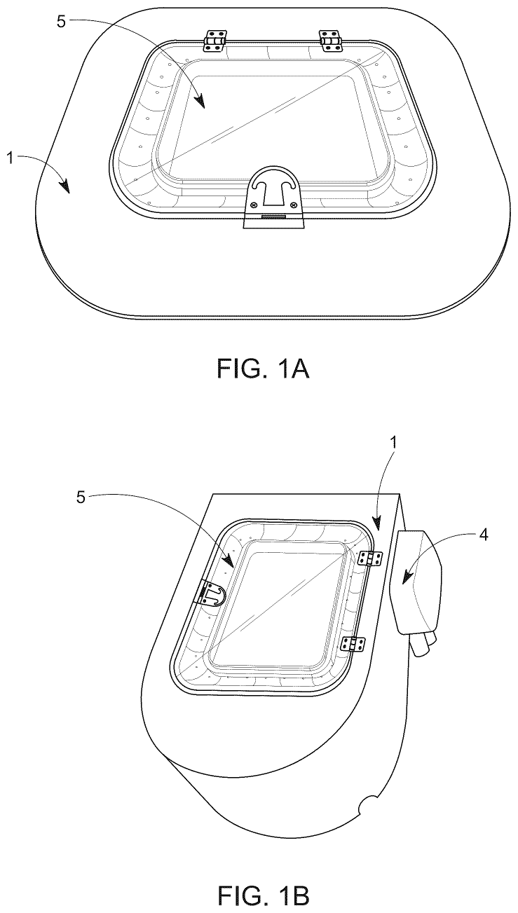

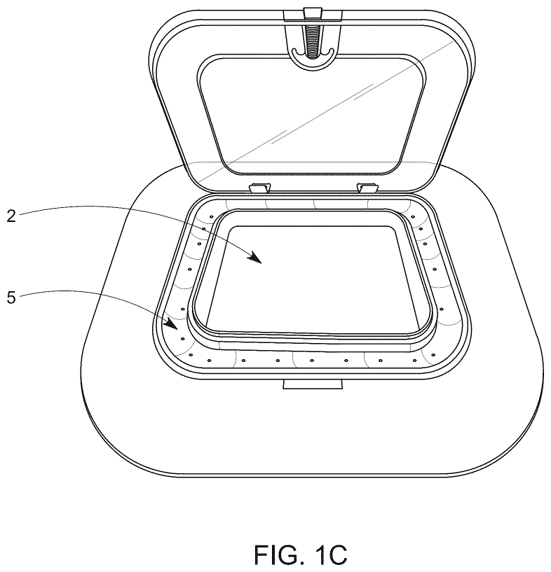

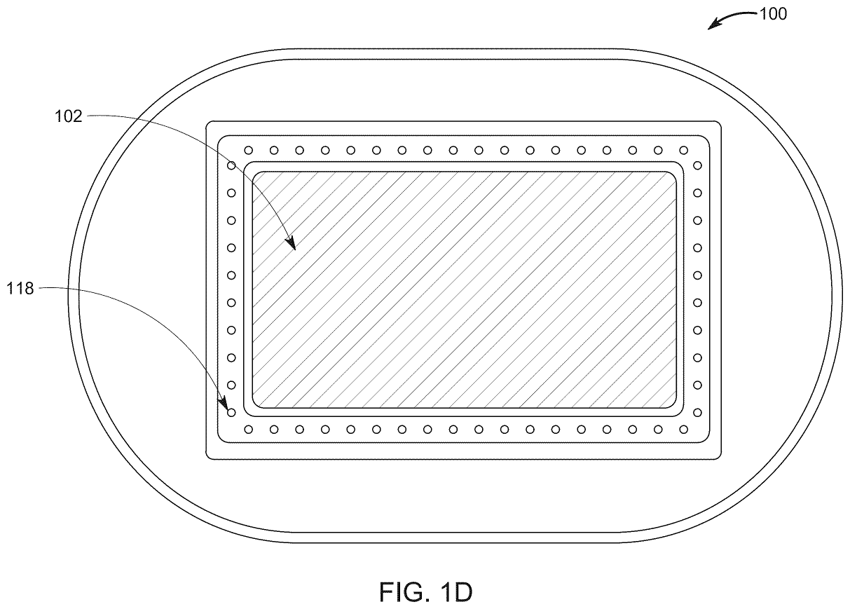

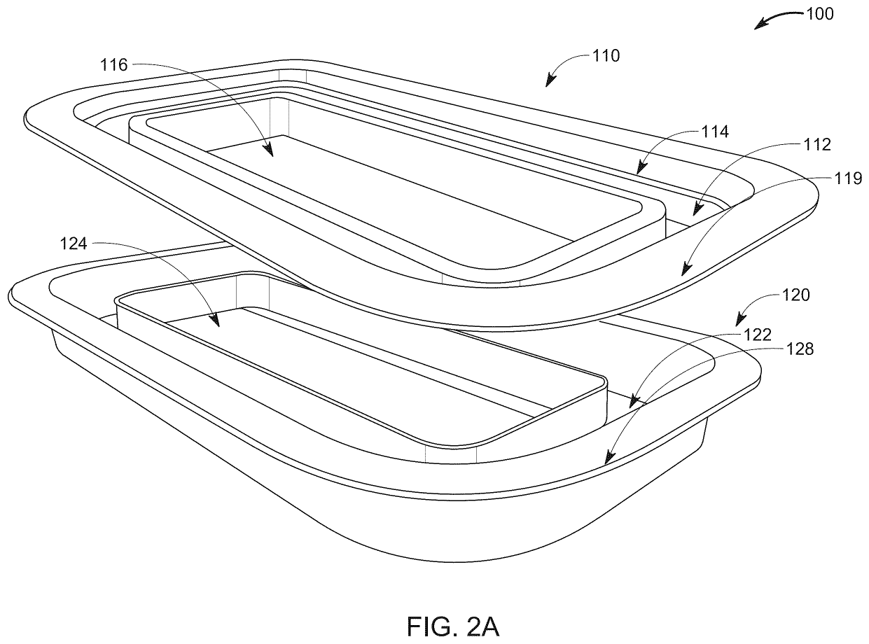

FIGS. 1A-1D illustrate perspective views of an exemplary spillover apparatus integrated into a portion of a livewell for preventing water from spilling out of a reservoir of the livewell in accordance with various embodiments of the present disclosure. In various embodiments, the livewell may comprise a housing 1 forming at least a reservoir and an opening 2. The livewell may further comprise a drain chamber 4 in fluid connection with the livewell and/or spillover apparatus. In various embodiments, a lid 5 may be positioned on an upper surface of the housing 1. The lid 5 may be selectively open and/or closed such that, the lid 5 provides access to the livewell reservoir in an open position. The lid 5 may include at least one fastening mechanisms that secures at least a portion of the lid 5 to the housing 1. In one or more embodiments, the housing 1 may be constructed from at least one composite material that provides structural reinforcement and sealing capabilities. In some embodiments, the housing 1 may be made from at least one of Garolite, Micarta, fiberglass, carbon fiber, or a combination thereof.

In various embodiments, a spillover apparatus may be integrated into at least a portion of a livewell. In some embodiments, the spillover apparatus may be integrated into one or more livewells installed on a boat and/or one or more livewells integrated into a boat. In various embodiments, The spillover apparatus may be integrated into an upper surface of the livewell such that, the spillover apparatus my provide access to an interior of the livewell via at least one opening. In various embodiments, the integrated spillover apparatus may further comprise at least one hinge. The at least one hinge may enable a lid to be selectively opened and/or closed.

With reference to FIG. 1C, an opening of the livewell 2 may be positioned to provide access to the reservoir of the livewell. In various embodiments, the opening of the livewell 2 may be a rectangular shape. In other embodiments, the opening of the livewell 2 may a different shape (e.g., circular, square, oval, triangular, etc.). In various embodiments, a spillover apparatus 3 (e.g., recessed gutter) may be positioned around the opening of the livewell 2, defining a channel that extends around at least a portion of the opening of the livewell 2. The spillover apparatus 3 may comprise a spillover area with at least one drain hole drilled into it. In various embodiments, the spillover apparatus 3 may be configured to collect spillover liquid from the opening of the livewell 2 and direct the spillover liquid back into the reservoir of the livewell and/or to a return chamber 4. In various embodiments, the return chamber 4 may facilitate drainage of overflow liquid through integrated ports or valves connected to external plumbing systems. The return chamber 4 may work in coordination with the spillover apparatus 3 to capture and direct spillover liquid away from the boat deck.

With reference to FIG. 1D, a spillover apparatus 100 may be configured for use with livewell systems to manage spillover liquid. In various embodiments, the spillover apparatus 100 may be integrated into at least a portion of the housing 1 of the livewell. In other embodiments, at least a portion of the spillover apparatus may be positioned within a portion of the opening of the livewell 102. The spillover apparatus 100 may include a central opening (e.g., a first opening and/or a second opening) that aligns with at least a portion of the opening of the livewell 102, maintaining access to the reservoir of the livewell.

The spillover apparatus 100 may define at least one channel (e.g., first channel, second channel, etc.) that extends around at least a portion of the perimeter of the spillover apparatus 100. In various embodiments, the parameter of the at least one channel may be greater than or equal to the parameter of the opening of the livewell. In one or more embodiments, the at least one channel may comprise one or more drain holes 118. The one or more drain holes may be positioned along at least a portion of a bottom surface and/or at least one side surface of the at least one channel. In other embodiments, the one or more drain holes 118 may be positioned along a bottom surface of the at least one channel and/or along one or more additional surfaces (e.g., left wall and/or right wall) of the at least one channel. In various embodiments, the one or more drain holes may be evenly spaced along the bottom surface and/or the one or more additional surfaces (e.g., left wall and/or right wall) of the at least one channel. In other embodiments, the one or more drain holes 118 may be unevenly space along the bottom surface and/or the one or more additional surfaces (e.g., left wall and/or right wall) of the at least one channel.

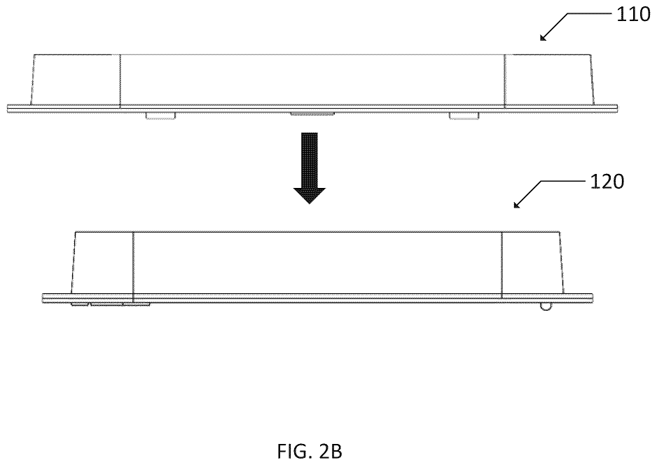

FIGS. 2A-2B illustrate exemplary exploded perspective views of a spillover apparatus 100 in accordance with various embodiments of the present disclosure. In various embodiments, the spillover apparatus 100 may comprise a first portion 110 and/or a second portion 120. In one or more embodiments, the first portion 110 may define a first opening 116 and a first channel 112. The first channel may extend around at least a portion of the perimeter of the first portion 110 and may be configured to create a collection area configured to collect spillover liquid from the livewell opening. The first channel 112 may be configured with a perimeter that is greater than or equal to the perimeter of an opening of a livewell. In various embodiments, the first channel 112 may extend along the entire perimeter of the first portion 110 to provide complete circumferential coverage for spillover collection. In other embodiments, the first channel 112 may extend along only a portion of the perimeter of the first portion 110, allowing for customized overflow management based on specific livewell configurations or installation requirements.

In various embodiments, the first portion 110 may further comprise a first ridge 114 that extends along at least a portion of the perimeter of the first portion 110. The first ridge 114 may be positioned to interface with sealing mechanisms such as gaskets on a lid to create a sealed connection. In various embodiments, the first ridge 114 may extend along the entire perimeter of the first portion 110 to provide complete sealing capability around the circumference. In other embodiments, the first ridge 114 may extend along only a portion of the perimeter of the first portion 110 to accommodate specific sealing requirements or structural considerations. In various embodiments, the first channel 112 and the first ridge 114 may extend the same difference along the perimeter of the first portion 110. In other embodiments, the first channel 112 and the first ridge 114 may extend different distances along the perimeter of the first portion 110.

In various embodiments, the first portion may further comprise a first lip 119. The first lip 119 may extend around at least a portion of the outer perimeter of the first portion 110. The first lip 119 may include a bottom surface configured to contact a corresponding surface of the second portion 120 and/or a livewell structure when the spillover apparatus 100 is installed. The first lip 119 may extend along the entire perimeter of the first portion 110. In other embodiments, the first lip 119 may extend along only a portion of the perimeter of the first portion 110 based on installation requirements.

In one or more embodiments, the first channel 112 may further comprise one or more drain holes (depicted in FIG. 1D) positioned along at least one surface of the first channel 112. The one or more drain holes may be positioned along at least a portion of a bottom surface of the first channel 112. In other embodiments, the one or more drain holes may be positioned along a bottom surface of the first channel 112 and/or along one or more additional surfaces (e.g., left wall and/or right wall) of the first channel 112. In various embodiments, the one or more drain holes may be evenly spaced along the bottom surface and/or the one or more additional surfaces (e.g., left wall and/or right wall) of the first channel 112. In other embodiments, the one or more drain holes be unevenly space along the bottom surface and/or the one or more additional surfaces (e.g., left wall and/or right wall) of the first channel 112. In various embodiments, the one or more drain holes may provide fluid communication between the first channel 112 and at least a portion of lower portion (e.g., the second channel 112) of the spillover apparatus 100, allowing collected spillover liquid to drain from the first portion 110 to the second portion 120.

In various embodiments, the spillover apparatus 100 may further comprise a second portion 120. The second portion 120 may be positioned beneath at least a portion of the first portion 110. The second portion 120 may define a second opening 124 that aligns with at least a portion of the opening of the livewell and/or with at least a portion of the first opening 116. In various embodiments, the second portion 120 may further define a second channel 122. The second channel 122 may extend around at least a portion of the perimeter of the second portion 120. The second channel 122 may be configured to receive spillover liquid that drains from the first channel 112 via the one or more drain holes 118. The second channel 122 may be configured with a predetermined depth to provide adequate capacity for collecting overflow water that drains from an upper collection level. The second channel 122 may have a perimeter that is greater than or equal to the perimeter of an opening of a livewell. In various embodiments, the first channel 112 and the second channel 122 comprise the same perimeter. In other embodiments, the first channel and the second channel comprise different perimeters.

In various embodiments, the second portion 120 may further define a second lip 128 extending around at least a portion of the outer perimeter of the second portion 120. The second lip 128 may include a top surface configured to contact the bottom surface of the first lip 119 and/or a portion of a livewell structure when the spillover apparatus 100 is assembled and installed. In some embodiments, the second lip 128 may extend along the entire perimeter of the second portion 120. In other embodiments, the second lip 128 may extend along only a portion of the perimeter of the second portion 120 based on installation and sealing requirements.

With further reference to FIG. 2A, the exemplary exploded view may demonstrate how the first portion 110 may be positioned on top of the second portion 120 during assembly and/or installation. In various embodiments, the first opening 116 may be configured to align with at least a portion of the second opening 124 to provide continuous access to the livewell reservoir. With reference to FIG. 2B, the spillover apparatus may be assembled by positioning the first portion 110 on top of at least a portion of the second portion 120. This assembled view may illustrate the vertical arrangement of the components and demonstrate how the portions fit together when installed and/or integrated into a livewell system. The first portion 110 and second portion 120 may be aligned such that their respective openings are substantially aligned to allow continuous access through the apparatus. In the assembled configuration, the first portion 110 may be disposed above and at least partially overlapping the second portion 120. This positioning may create a stacked arrangement where the first portion 110 forms an upper component and the second portion 120 forms a lower component of the spillover apparatus. The vertical arrangement may allow the first portion 110 to collect spillover liquid and direct the liquid to the second portion 120 positioned beneath.

The alignment of the openings in the assembled configuration may provide unobstructed access to the livewell interior (e.g., reservoir). The first portion 110 may collect spillover liquid in its channel and allow the liquid to drain to the channel of the second portion 120 through fluid communication features (e.g., one or more drain holes). The positioning shown in the assembled configuration may facilitate installation of the spillover apparatus into existing livewell systems. The coordinated alignment of the first portion 110 and second portion 120 may allow the apparatus to be inserted as a unit or assembled in place within the livewell opening. In various embodiments, the spillover apparatus 100 may retrofitted to existing livewells by installing at least a portion of the spillover apparatus 100 into the opening of the existing livewell. In various embodiments, the first portion 110 and the second portion 120 may be installed simultaneously (e.g., together). In other embodiments, the first portion 110 and the second portion 120 may be installed individually. In various embodiments, at least a portion of the first portion 110 and/or the second portion 120 to at least a portion of the livewell (e.g., outer portion of the housing, inner portion of the housing, opening of the livewell, etc.) using at least one of a fastener, adhesive, fiberglass reinforcement, or a combination thereof. In other embodiments, the spillover apparatus 100 may be integrated into a livewell such that, the spillover apparatus 100 is a portion of the livewell.

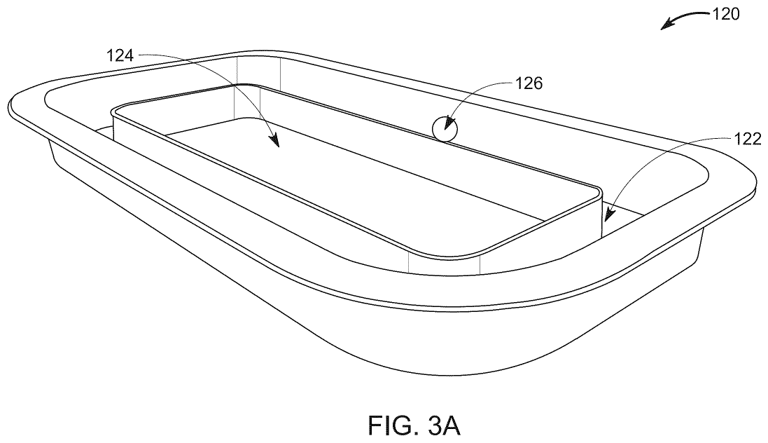

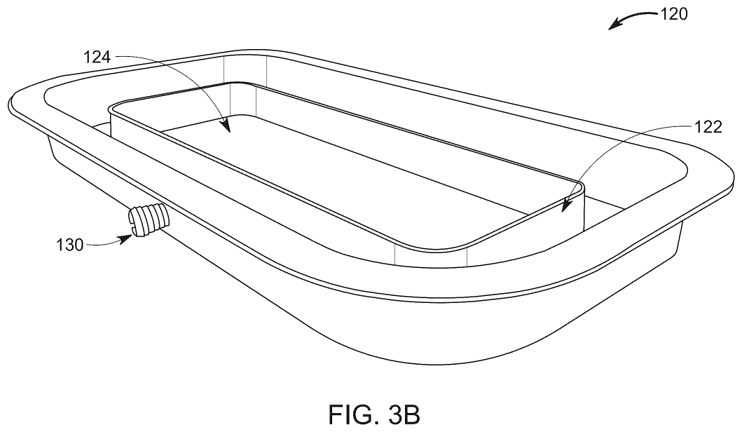

FIGS. 3A-3B illustrate perspective views of a second portion 120 in accordance with various embodiments of the present disclosure. The second portion 120 may further comprise at least one port 126. The at least one port 126 may be disposed at one or more locations along the second channel 122 of the second portion 120 to facilitate management of spillover liquid collected by the spillover apparatus 100. The at least one port 126 may be positioned within or adjacent to the second channel 122 to provide fluid communication between the collected overflow water and external drainage systems (e.g., drain chamber 4 described above). The at least one port 126 may be configured to remove spillover liquid from the second channel 122 and/or to direct the spillover liquid away from the reservoir livewell system or other collection areas.

In various embodiments, the at least one port 126 may be further configured to connect to at least one drainage devices to manage the spillover liquid collected by the spillover apparatus 100. In various embodiments, the at least one port 126 may be connected to a pump that actively removes spillover liquid from the second channel 122 and away from the reservoir of the livewell. In various embodiments, the at least one port 126 may also be connected to an exit line that removes the spillover liquid from the boat entirely, preventing accumulation of excess liquid.

In various embodiments, the positioning of the at least one port 126 may be configured to optimize the draining of the spillover liquid from the second channel 122 of the spillover apparatus 100. In various embodiments, the at least one port 126 may be disposed along at least one side wall of the second channel 122. In other embodiments, the at least one port 126 may be disposed along a bottom surface of the second channel 122, allowing gravity-assisted drainage of the spillover liquid from the spillover apparatus 100.

The second portion 120 may be configured to accommodate multiple drainage options through the use of multiple ports. In some embodiments, the second portion 120 may comprise two or more ports that provide enhanced drainage capability for the second channel 122. The multiple ports may be disposed opposite to each other providing balanced drainage from different areas of the second channel 122. In other embodiments, the multiple ports may be disposed at various locations around the second portion 120 based on specific drainage requirements or plumbing configurations of the boat system. In various embodiments, the at least one port 126 may be designed to integrate with existing boat plumbing systems, allowing the spillover apparatus to work in coordination with established water management infrastructure. The at least one port 126 may include connection features that accommodate standard plumbing fittings and connections used in marine applications. This integration capability may allow boat operators to incorporate the spillover apparatus into their existing livewell systems without requiring extensive modifications to established plumbing arrangements.

The second portion 120 may be configured for insertion at least partially into an opening of an existing livewell, enabling retrofitting of livewell systems with overflow collection and pressurization capabilities. The port 126 may facilitate this retrofitting process by providing a connection point for integrating the spillover apparatus with existing drainage and water management systems. The positioning and configuration of the port 126 may allow for flexible installation options that accommodate various livewell designs and boat configurations.

With reference to FIG. 3B, the second portion 120 may further include at least one valve 130 connected to the at least one port of the second portion 120. The at least one valve 130 may provide enhanced control over fluid communication between the second channel 122 and external plumbing components. The at least one valve 130 may be disposed along the second portion 120 to facilitate precise management of overflow liquid collected in the second channel 122. The valve 130 may function to control the flow of the spillover liquid from the second channel 122 to various external systems, providing boat operators with adjustable drainage capabilities.

The at least one valve 130 may be positioned to provide direct fluid communication between the second channel 122 and external plumbing components such as return lines, exit lines, or pump systems. The at least one valve 130 may facilitate the removal of spillover liquid from the second channel 122 by providing a controlled pathway for liquid to exit the collection area.

In various embodiments, the at least one valve 130 may provide multiple routing options for managing spillover liquid collected by the spill over apparatus. The at least one valve 130 may direct spillover liquid to be recycled back into the livewell, maintaining liquid levels, or direct the spillover liquid away from the reservoir of the livewell. In various embodiments, the at least one valve 130 may route spillover liquid to be stored in another chamber within the boat's water management system, allowing for temporary storage or further processing. In other embodiments, the at least one valve 130 may facilitate drainage of spillover liquid out of the boat entirely, preventing accumulation of excess liquid.

In various embodiments, the second portion 120 may be configured to accommodate multiple valve arrangements to enhance drainage capability and provide redundant overflow management. In some embodiments, the second portion 120 may comprise two or more valves that provide enhanced control over overflow liquid removal from the second channel 122. The multiple valves may be disposed opposite to each other around the perimeter of the second portion 120, providing balanced drainage from different areas of the second channel 122 and ensuring comprehensive liquid management.

The positioning of multiple valves may be configured based on specific drainage requirements or plumbing configurations of the boat system. The two or more valves may be disposed at any desirable location around the second portion 120 to accommodate existing plumbing infrastructure or to optimize drainage efficiency based on boat orientation and operating conditions. This flexible positioning capability may allow boat operators to customize the overflow management system to match their specific operational requirements and existing equipment configurations. In one or more embodiments, the at least one valve 130 may be designed to integrate with existing boat plumbing systems while providing enhanced control over overflow liquid management. The at least one valve 130 may include control mechanisms that allow boat operators to adjust drainage rates or to selectively direct overflow liquid to different destinations based on operating conditions. This controllable drainage capability may provide boat operators with greater flexibility in managing livewell water levels and overflow conditions during various fishing activities and sea conditions.

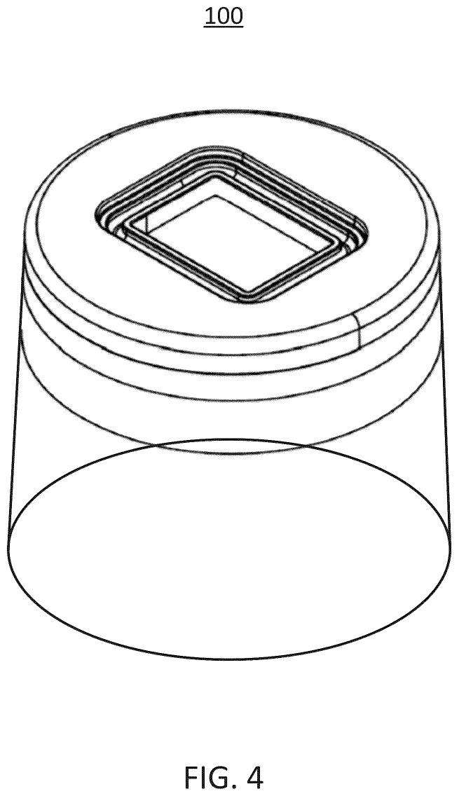

FIG. 4 illustrates a perspective view of an exemplary spillover apparatus in accordance with embodiments of the present disclosure. In various embodiments, the spillover apparatus 100 (e.g., the first portion and/or the second portion) may be configured to be retroactively attached to an existing livewell. In various embodiments, the spillover apparatus 100 may be configured to attach to a portion of an existing livewell such that, a portion of the spillover apparatus may be inserted into the opening of the livewell and/or a portion of the spillover apparatus may contact and external surface of the existing livewell. In other embodiments, the spillover apparatus 100 may be incorporated into at least a portion of a livewell. In various embodiments, the spillover apparatus 100 may be integrated into one or more livewells installed on a boat and/or one or more livewells integrated into a boat such that, the spillover apparatus 100 is a portion of the one or more livewells. For example, the spillover apparatus 100 may be a part of the one or more livewells integrated into the transoms and/or other portion of the boat. The boat may be an existing boat or the boat maybe a boat in the process of being built.

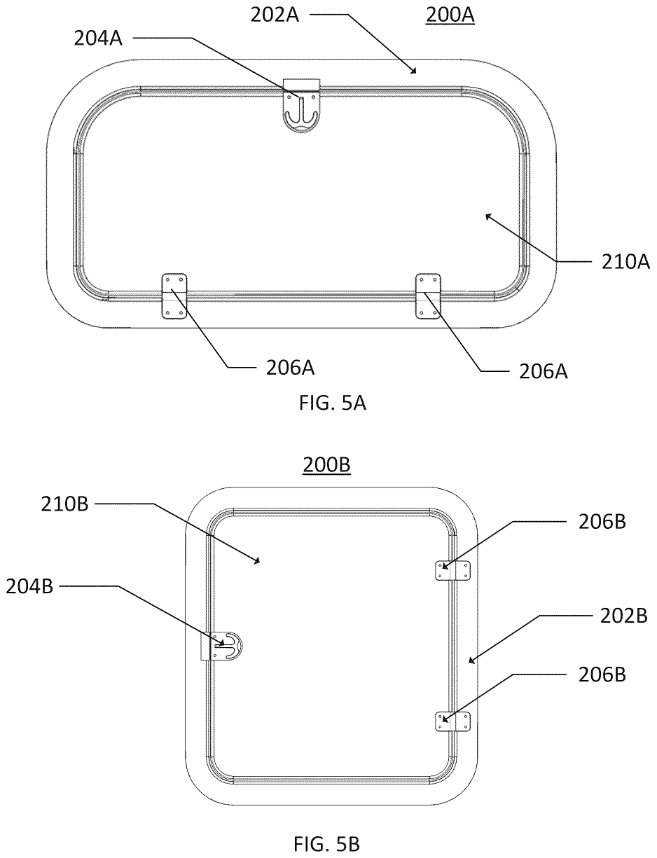

FIGS. 5A-5B illustrate perspective views of a lid for a spillover apparatus in accordance with various embodiments of the present disclosure. In various embodiments a lid may be provided to interface with the spillover apparatus and create sealing arrangements that enable pressurization of livewell systems. The lid configurations may include different arrangements of sealing, locking, and hinge mechanisms to accommodate various installation requirements and operational preferences for livewell applications.

In various embodiments, a lid 200A, 200B (collectively “200”) may be configured to provide sealing and access control for the spillover apparatus. The lid 200 may include a top surface 210A, 210B (collectively “210) that forms the primary structural element of the lid configuration. The top surface 210 may be constructed from materials that provide durability and resistance to marine environments while maintaining the structural integrity needed for pressurization applications. In various embodiments, the lid 200 may further comprise a lip 202A, 202B (collectively “202) extending around the perimeter of the lid 200. The lip 202 may be configured to interface with the first ridge of the first portion to create a sealing connection that prevents pressure loss and overflow spillage. The lip 202 may be positioned to align with sealing surfaces of the spillover apparatus when the lid 200 is in a closed configuration.

In various embodiments, the lid 200 can be countersunk into the top of the livewell, allowing for a tight, flush fit against the first ridge that meets the first lid gasket to prevent leaking even before water reaches the drain holes. The lid may be connected to the housing via one or more hinges at least one hinge 206A, 206B (collectively “206”). In some embodiments, a reinforcing and sealing material (such as Garolite, Micarta, fiberglass, carbon fiber, or other composite materials) may be situated below strike plates of the hinges to help reinforce and seal the connection of the lid to the latches and hinges. The reinforcing and sealing material can help to strengthen the livewell to prevent damage and also helps to seal the livewell so that the livewell can be maintained at a sufficient pressure.

In various embodiments, the lid 200 may further comprise at least one locking mechanism 204A, 204B (collectively “204”). In various embodiments, the at least one locking mechanism 204 may be positioned on at least a portion of the lid 200 to provide secure closure and maintain sealing pressure between the lid 200 and the spillover apparatus. The at least one locking mechanism 204 may be disposed at a central location on the top surface 210, providing convenient access for boat operators while distributing closure forces evenly across the sealing interface. The at least one locking mechanism 204 may provide a means for securing the lid 200 in a closed position to maintain pressurization of the livewell system.

The lid 200 may include at least one hinges 206 that enable the lid 200 to be selectively opened and closed relative to the spillover apparatus. The hinges 206 may be disposed along an edge of the lid 200, positioned symmetrically to provide balanced support for the lid 200 during opening and closing operations. The hinges 206 may allow the lid 200 to pivot between open and closed positions while maintaining proper alignment with sealing surfaces of the spillover apparatus.

The lid configurations may be constructed as acrylic lids that provide transparency for visual monitoring of livewell contents while maintaining the structural properties needed for pressurization applications. The acrylic construction may offer resistance to marine environments while allowing boat operators to observe fish and water conditions within the livewell without opening the lid and compromising pressurization. In various embodiments, the lid configuration may further incorporate dual gasket arrangements that provide enhanced sealing capability for pressurization applications. A first gasket may be configured to seal against the first ridge of the first portion, creating a primary sealing interface that prevents pressure loss and overflow spillage. A second gasket may be configured to seal against an outer lip of the first portion, providing a secondary sealing interface that enhances the overall sealing performance of the lid system.

The dual gasket arrangement may be spaced to match up flush to the first ridge of the first portion, ensuring proper alignment and sealing contact between the gaskets and the corresponding sealing surfaces of the spillover apparatus. The spacing of the dual gaskets may be configured to accommodate the specific geometry of the first ridge and outer lip of the first portion, providing optimal sealing performance while maintaining ease of operation for opening and closing the lid.

The dual gasket configuration may provide redundant sealing that enhances the reliability of pressurization systems and reduces the risk of pressure loss during livewell operation. The first gasket may provide primary sealing against the first ridge, while the second gasket may provide backup sealing against the outer lip, creating a dual-barrier system that maintains pressurization even if one sealing interface experiences wear or minor misalignment.

The lid configurations may be designed to create a closed system capable of maintaining pressure differentials that benefit fish health and livewell performance. The sealing interfaces created by the lip arrangements and dual gasket systems may work in coordination with the spillover apparatus to prevent pressure loss while maintaining overflow management capabilities. The pressurization functionality may be maintained during various operating conditions, allowing the livewell system to provide optimal fish habitat while managing water overflow effectively.

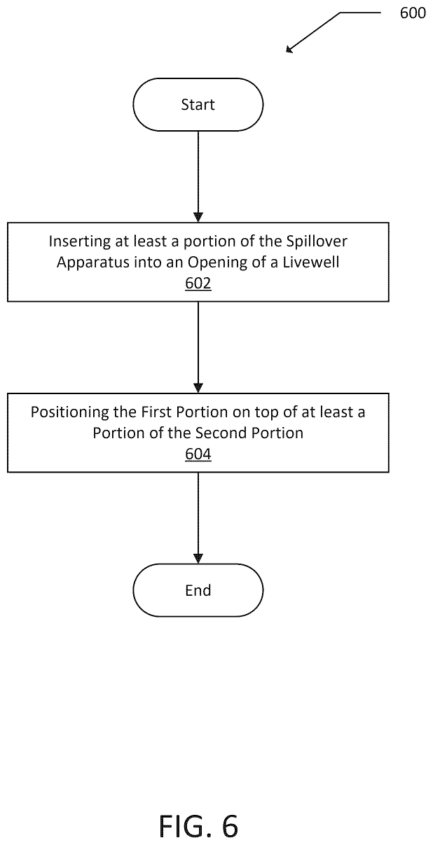

FIG. 6 illustrates an exemplary flow diagram showing a method 600 for installing a spillover apparatus into a livewell systems with the spillover apparatus in accordance with various embodiments of the present disclosure. The spillover apparatus can comprise a first portion and a second portion as previously described in relation to FIGS. 1A-5B. The method 600 may provide a structured approach for upgrading livewell installations without requiring complete replacement of existing livewell infrastructure. The method 600 may allow boat operators to enhance their existing equipment with advanced water management features through a systematic installation process.

The method 600 may begin with inserting 602 at least a portion of the spillover apparatus may be inserted into an opening of a livewell. The step 602 may involve positioning at least a portion of the spillover apparatus within the existing livewell opening. During the step 602, the spillover apparatus may be aligned with the opening of the livewell to ensure proper fit and positioning for subsequent installation steps.

The insertion process of the step 602 may involve aligning the second opening of the second portion with at least a portion of the opening of the livewell. This alignment may ensure that access to the livewell interior is maintained. The step 602 may also involve aligning the first opening of the first portion with at least a portion of the second opening to create continuous access through the spillover apparatus components.

The method 600 can further include positioning 604 the first portion on top of at least a portion of the second portion. The first portion may be positioned such that, the first portion may be in fluid communication with the second portion. This fluid communication may allow spillover liquid collected in the first channel to drain to the second channel, where the liquid may be further managed through the port and/or valve connections to external drainage systems. The step 604 may ensure that the spillover apparatus functions as an integrated system for collecting and directing overflow water.

The method 600 may accommodate different installation approaches based on specific livewell configurations and operational requirements. In some cases, the first portion and the second portion may be inserted simultaneously during the step 602, allowing the spillover apparatus to be installed as a pre-assembled unit. This simultaneous insertion approach may simplify the installation process and ensure proper alignment between the components from the outset.

In other cases, the first portion and the second portion may be inserted individually during the method 600. The individual insertion approach may allow for more precise positioning of each component and may accommodate livewell configurations where space constraints or access limitations make simultaneous insertion impractical. The individual insertion method may provide greater flexibility in accommodating various livewell designs and installation conditions.

The method 600 may include securing at least a portion of the first portion and the second portion to at least a portion of the livewell to create a permanent installation. The securing process may involve using fasteners that provide mechanical attachment between the spillover apparatus and the existing livewell structure. The fasteners may include screws, bolts, or other mechanical fastening devices that create secure connections capable of withstanding marine operating conditions.

The permanent installation may also be accomplished using adhesive materials that create chemical bonds between the spillover apparatus and the livewell structure. The adhesive materials may include marine-grade adhesives that provide long-term bonding capability in marine environments while maintaining resistance to water exposure and temperature variations. The adhesive installation method may provide seamless integration between the spillover apparatus and existing livewell components.

A fiberglass spray process and/or fiberglass brush process may be used as part of the permanent installation process to create structural integration between the spillover apparatus and the livewell. The fiberglass spray process and/or fiberglass brush process may involve applying fiberglass materials around the interface between the spillover apparatus and the livewell structure, creating a reinforced connection that distributes loads and enhances structural integrity. The fiberglass spray process and/or fiberglass brush process method may provide enhanced durability and sealing capability for the installation.

The permanent installation may involve combinations of fasteners, adhesive materials, and fiberglass reinforcement to provide comprehensive attachment and sealing between the spillover apparatus and the livewell. The combination approach may utilize the advantages of multiple attachment methods to create installations that provide enhanced security, sealing, and structural integrity. The combination installation method may be particularly suitable for applications where maximum reliability and durability are required.

The method 600 may further include installing the lid configured to seal against the first ridge of the first portion to enable pressurization of the livewell. The lid installation may create the sealing interfaces needed to maintain pressure differentials within the livewell system while providing access capability for livewell operations. The lid may be connected to the spillover apparatus through the hinges to provide convenient opening and closing functionality.

The method 600 may include connecting the port to at least one drainage device to remove spillover liquid from the second channel. The drainage device connection may involve linking the port to return lines that direct overflow liquid back to the livewell reservoir, allowing for recycling of water within the livewell system. The drainage device may also include exit lines that remove overflow liquid from the boat entirely, or pumps that actively manage the flow of overflow liquid from the second channel.
Clause 1: A method of installing an apparatus into a livewell, the method comprising: inserting at least a portion of a spillover apparatus into an opening of the livewell, the spillover apparatus comprising: a first portion defining a first opening and a first channel extending around at least a portion of the first portion; and a second portion defining a second opening and a second channel extending around at least a portion of the second portion; positioning the first portion on top of at least a portion of the second portion such that, the first channel of the first portion collects spillover liquid from the opening of the livewell, wherein the inserting comprises: aligning the second opening with at least a portion of the opening of the livewell; and aligning the first opening with at least a portion of the second opening.
Clause 2: The method of Clause 1, wherein the first channel comprises one or more drain holes positioned along a bottom surface and/or at least one side surface of the first channel providing fluid communication between the first channel and the second channel.
Clause 3: The method of Clause 2, wherein the one or more drain holes are spaced evenly along the bottom surface and/or the at least one side surface of the first channel; or the one or more drain holes are spaced unevenly along the bottom surface and/or the at least one side surface of the first channel.
Clause 4: The method of Clause 1, wherein the first portion and the second portion are inserted simultaneously.
Clause 5: The method of Clause 1, wherein the first portion and the second portion are inserted individually.
Clause 6: The method of Clause 1, further comprising securing at least a portion of the first portion and/or the second portion to at least a portion of the livewell using at least one of a fastener, adhesive, fiberglass reinforcement, or a combination thereof.
Clause 7: The method of Clause 1, further comprising installing a lid configured to seal against a first ridge of the first portion to enable pressurization of the livewell.
Clause 8: The method of Clause 1, wherein the second portion comprises at least one port disposed along a portion of the second channel.
Clause 9: The method of Clause 8, further comprising connecting the at least one port to at least one drainage device to remove the spillover liquid from the second channel.
Clause 10: The method of Clause 9, wherein the at least one drainage device is at least one of a return line, exit line, pump, or a combination thereof.
Clause 11: The method of Clause 9, wherein the at least one drainage device is configured to allow the spillover liquid to flow from the second channel and away from a reservoir of the livewell.
Clause 12: An apparatus for a livewell, the apparatus comprising: a first portion defining a first opening aligned with at least a portion of a second opening and a first channel extending around at least a portion of the first portion, the first channel configured to collect spillover liquid from the first opening; and a second portion disposed at least partially beneath the first portion and defining the second opening aligned with at least a portion of an opening of the livewell and a second channel extending around at least a portion of the second portion, the second channel configured to receive spillover liquid from the first channel, wherein at least a portion of the first portion and/or the second portion is configured to be secured to the livewell.
Clause 13: The apparatus of Clause 12, wherein: the first channel and/or the second channel comprises a predetermined depth configured to collect the spillover liquid; and the first channel and/or the second channel comprises a perimeter greater than or equal to the perimeter of an opening of the livewell.
Clause 14: The apparatus of Clause 12, wherein at least a portion of the first portion and/or the second portion is secured using at least one of a fastener, adhesive material, fiberglass attachment method, or a combination thereof.
Clause 15: The apparatus of Clause 12, further comprising at least one port disposed along a portion of the second channel, wherein the at least one port allows the liquid to flow from the second channel and away from a reservoir of the livewell.
Clause 16: The apparatus of Clause 15, wherein the at least one port is connected to at least one of a return line, exit line, pump, or a combination thereof.
Clause 17: The apparatus of Clause 12, further comprising one or more drain holes positioned along a bottom surface and/or at least one side surface of the first channel providing fluid communication between the first channel and the second channel.
Clause 18: The apparatus of Clause 17, wherein: the one or more drain holes are spaced evenly along the bottom surface and/or the at least one side surface of the first channel; or the one or more drain holes are spaced unevenly along the bottom surface and/or the at least one side surface of the first channel.
Clause 19: The apparatus of Clause 12, further comprising a lid hingedly connected to the first portion and configured to be selectively opened and/or closed, wherein the lid is configured to prevent liquid from spilling over and pressurize the livewell.
Clause 20: A livewell comprising the apparatus of Clause 12.

While certain examples of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of installing an apparatus into a livewell, the method comprising:
inserting at least a portion of a spillover apparatus into an opening of the livewell, the spillover apparatus comprising:
a first portion defining a first opening and a first channel extending around at least a portion of the first portion; and
a second portion defining a second opening and a second channel extending around at least a portion of the second portion;
positioning the first portion on top of at least a portion of the second portion such that, the first channel of the first portion collects spillover liquid from the opening of the livewell,
wherein the inserting comprises:
aligning the second opening with at least a portion of the opening of the livewell; and
aligning the first opening with at least a portion of the second opening.

2. The method of claim 1, wherein the first channel comprises one or more drain holes positioned along a bottom surface and/or at least one side surface of the first channel providing fluid communication between the first channel and the second channel.

3. The method of claim 2, wherein:
the one or more drain holes are spaced evenly along the bottom surface and/or the at least one side surface of the first channel; or
the one or more drain holes are spaced unevenly along the bottom surface and/or the at least one side surface of the first channel.

4. The method of claim 1, wherein the first portion and the second portion are inserted simultaneously.

5. The method of claim 1, wherein the first portion and the second portion are inserted individually.

6. The method of claim 1, further comprising securing at least a portion of the first portion and/or the second portion to at least a portion of the livewell using at least one of a fastener, adhesive, fiberglass reinforcement, or a combination thereof.

7. The method of claim 1, further comprising installing a lid configured to seal against a first ridge of the first portion to enable pressurization of the livewell.

8. The method of claim 1, wherein the second portion comprises at least one port disposed along a portion of the second channel.

9. The method of claim 8, further comprising connecting the at least one port to at least one drainage device to remove spillover liquid from the second channel.

10. The method of claim 9, wherein the at least one drainage device is at least one of a return line, exit line, pump, or a combination thereof.

11. The method of claim 9, wherein the at least one drainage device is configured to allow the spillover liquid to flow from the second channel and away from a reservoir of the livewell.

12. An apparatus for a livewell, the apparatus comprising:
a first portion defining a first opening aligned with at least a portion of a second opening and a first channel extending around at least a portion of the first portion, the first channel configured to collect spillover liquid from the first opening; and
a second portion disposed at least partially beneath the first portion and defining the second opening aligned with at least a portion of an opening of the livewell and a second channel extending around at least a portion of the second portion, the second channel configured to receive spillover liquid from the first channel,
wherein at least a portion of the first portion and/or the second portion is configured to be secured to the livewell.

13. The apparatus of claim 12, wherein:
the first channel and/or the second channel comprises a predetermined depth configured to collect the spillover liquid; and
the first channel and/or the second channel comprises a perimeter greater than or equal to the perimeter of an opening of the livewell.

14. The apparatus of claim 12, wherein at least a portion of the first portion and/or the second portion is secured using at least one of a fastener, adhesive material, fiberglass attachment method, or a combination thereof.

15. The apparatus of claim 12, further comprising at least one port disposed along a portion of the second channel, wherein the at least one port allows the liquid to flow from the second channel and away from a reservoir of the livewell.

16. The apparatus of claim 15, wherein the at least one port is connected to at least one of a return line, exit line, pump, or a combination thereof.

17. The apparatus of claim 12, further comprising one or more drain holes positioned along a bottom surface and/or at least one side surface of the first channel providing fluid communication between the first channel and the second channel.

18. The apparatus of claim 17, wherein:
the one or more drain holes are spaced evenly along the bottom surface and/or the at least one side surface of the first channel; or
the one or more drain holes are spaced unevenly along the bottom surface and/or the at least one side surface of the first channel.

19. The apparatus of claim 12, further comprising a lid hingedly connected to the first portion and configured to be selectively opened and/or closed, wherein the lid is configured to prevent liquid from spilling over and pressurize the livewell.

20. A livewell comprising the apparatus of claim 12.
